(19) United States
(12) Patent Application Publication
(10) Pub. No.: US 2026/0203285 A1
(43) Pub. Date: Jul. 16, 2026

(54) INFORMATION PROCESSING APPARATUS, INFORMATION PROCESSING METHOD, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventor: Taiki HAMADA, Yokohama Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/449,666

(22) Filed: Jan. 15, 2026

(30) Foreign Application Priority Data
Jan. 15, 2025 (JP) 2025-005430

(51) Int. Cl. G06F 16/2453; G06F 16/28; G06F 40/279; G06F 40/40

(52) U.S. Cl. CPC G06F 16/24534; G06F 16/285; G06F 40/279; G06F 40/40

(57) ABSTRACT

According to one embodiment, an information processing apparatus includes a processor. The processor is configured to generate a query for searching data related to a question specified by a user, acquire a first search result by performing a search on a first database prepared in advance using a query, determine presence or absence of consistency between the question and the first search result, generate a prompt integrating the question and the first search result determined to have consistency with the question, and generate an answer to the question by inputting a prompt into a first language model prepared in advance.

### CROSS-REFERENCE TO RELATED APPLICATIONS

This application is based upon and claims the benefit of priority from Japanese Patent Application No. 2025-005430, filed January 15, 2025, the entire contents of which are incorporated herein by reference.

### FIELD

Embodiments described herein relate generally to an information processing apparatus, an information processing method, and a storage medium.

### BACKGROUND

In recent years, it has become possible to train a large language model (LLM) using vast amounts of text data. Such an LLM are used to realize generating an answer to a question posed in natural language.

By inputting a question related to knowledge (text data) that has been learned in advance, the aforementioned LLM can generate an appropriate answer to the question. On the other hand, in a case where a question related to knowledge that has not been learned is input, the LLM cannot generate an appropriate answer to the question, and a phenomenon called hallucination may occur, in which an answer that is contrary to the facts is generated.

Here, in order to generate an answer to a question related to knowledge that the LLM has not learned, the use of a pre-constructed database (a database in which the relevant knowledge is accumulated) may be considered. Specifically, by inputting a question related to knowledge that is not learned and data related to that question searched from the database, the LLM can generate an appropriate answer even for matters that are not learned.

However, in a case where the LLM generates an answer to a question using data searched from the aforementioned database, the accuracy (quality) of the answer to the question may decrease depending on the searched data.

### BRIEF DESCRIPTION OF THE DRAWINGS

FIG. 1 shows an example of a configuration of an information processing system in a first embodiment.

FIG. 2 shows an example of a configuration of an information processing apparatus.

FIG. 3 illustrates an overview of an operation of the information processing system.

FIG. 4 is a flowchart showing an example of a processing procedure of the information processing apparatus.

FIG. 5 shows an example of a configuration of an information processing system in a second embodiment.

FIG. 6 shows an example of a configuration of an information processing apparatus.

FIG. 7 illustrates an overview of an operation of the information processing system.

FIG. 8 is a flowchart showing an example of a processing procedure of the information processing apparatus.

FIG. 9 illustrates an example of a configuration of an information processing apparatus according to a third embodiment.

FIG. 10 illustrates an overview of an operation of an information processing system.

FIG. 11 is a flowchart showing an example of a processing procedure of the information processing apparatus.

FIG. 12 illustrates an overview of an operation of an information processing system in a fourth embodiment.

FIG. 13 is a flowchart showing an example of a processing procedure of an information processing apparatus.

### DETAILED DESCRIPTION

In general, according to one embodiment, an information processing apparatus includes a processor. The processor is configured to generate a query for searching data related to a question specified by a user, acquire a first search result by performing a search on a first database prepared in advance using the generated query, determine presence or absence of consistency between the question and the acquired first search result, generate a prompt integrating the question and a first search result determined to have consistency with the question, and generate an answer to the question by inputting the generated prompt into a first language model prepared in advance.

Various embodiments will be described with reference to the accompanying drawings.

### (First Embodiment)

First, a first embodiment will be described. An information processing apparatus according to the present embodiment corresponds to a question-response device or a question-response processing device having a function to respond with an answer to a question specified by a user, for example.

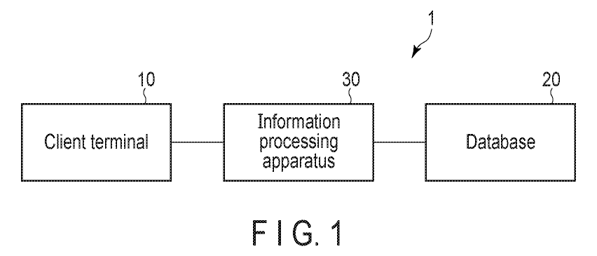

FIG. 1 shows an example of a configuration of an information processing system in the present embodiment. As shown in FIG. 1, an information processing system 1 includes a client terminal 10, a database 20, and an information processing apparatus 30.

The client terminal 10 is a terminal device (computer) used by the user who specifies (creates) the aforementioned question and is connected to the information processing apparatus 30 via a network. The client terminal 10 transmits the question specified by the user to the information processing apparatus 30.

The database 20 corresponds to an information source where various data are accumulated and is constructed to be accessible from the information processing apparatus 30 connected via the network. Note that although only one database 20 is shown in FIG. 1, the information processing system 1 may include a plurality of databases 20.

The information processing apparatus 30 receives the question transmitted from the client terminal 10 and generates an answer to that question. When generating the answer to the aforementioned question, the information processing apparatus 30 uses data matching the question searched from a large language model (LLM) and the database 20. The answer generated by the information processing apparatus 30 is transmitted to the client terminal 10.

That is, the information processing system 1 in the present embodiment can be said to be an interactive computer network system using the LLM.

Note that the information processing apparatus 30 is connected to the client terminal 10 and the database 20 via the network. The network in this case is, for example, a local area network (LAN); however, it may also be the Internet or a public communication line, etc. Furthermore, the connection to the network may be wired or wireless.

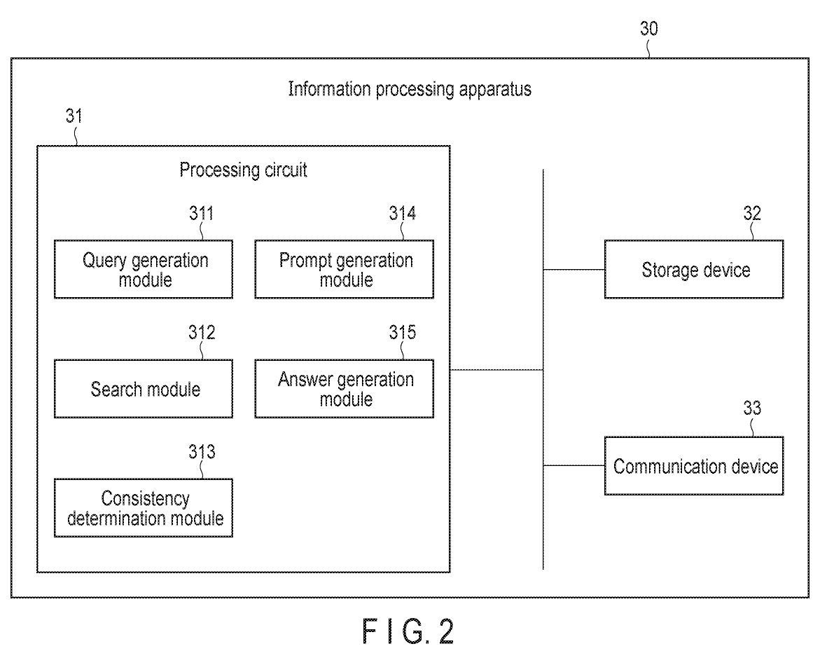

FIG. 2 shows an example of a configuration of the information processing apparatus 30 shown in FIG. 1. As shown in FIG. 2, the information processing apparatus 30 includes a processing circuit 31, a storage device 32, and a communication device 33.

The processing circuit 31 includes, for example, a processor such as a central processing unit (CPU) and memory such as random access memory (RAM). Note that the processing circuit 31 may have one or more processors.

The storage device 32 corresponds to a non-transitory computer-readable recording medium and includes, for example, read only memory (ROM), a hard disk drive (HDD), a solid state drive (SSD), or an integrated circuit storage device. The storage device 32 stores various programs, etc. The programs stored in the storage device 32 may be implemented as a single program or as a plurality of modules divided into predetermined functional units.

The communication device 33 corresponds to an interface for communicating with external devices connected to the information processing apparatus 30 via a network.

In the example shown in FIG. 2, the information processing apparatus 30 is described as including the processing circuit 31, the storage device 32, and the communication device 33. However, this information processing apparatus 30 may further include input devices such as a keyboard, a mouse, various switches, a touchpad, or a touch panel display, as well as display devices such as a cathode-ray tube (CRT) display, a liquid crystal display, an organic electro luminescence (EL) display, a light-emitting diode (LED) display, a plasma display, or any other displays. Note that the display device may also be, for example, a projector.

As shown in FIG. 2, the processing circuit 31 includes a query generation module 311, a search module 312, a consistency determination module 313, a prompt generation module 314, and an answer generation module 315.

In the present embodiment, each of modules 311 to 315 is realized by a program stored in the storage device 32 being executed by the processing circuit 31 (processor) (i.e., software).

Note that each of the modules 311 to 315 may be implemented, for example, by an application-specific integrated circuit (ASIC). In this case, each of the modules 311 to 315 may be implemented on a single integrated circuit or on a plurality of integrated circuits individually.

Here, the client terminal 10 described above includes, as hardware, a processor, memory, a storage device, a communication device, an input device, and a display device, and functions as a user interface in the information processing system 1. Specifically, the client terminal 10 accepts input of a question specified by the user via the input device. The question is text data corresponding to a query from the user. Note that the question may be a natural sentence, such as a question sentence, or may be a word, such as a search keyword. In the case of accepting the input of the question specified by the user as described above, the client terminal 10 transmits the question to the information processing apparatus 30.

The information processing apparatus 30 receives the question transmitted from the client terminal 10 via the communication device 33. Based on the received question, the query generation module 311 generates a query for searching data related to the question.

The search module 312 performs a search on the database 20 using the query generated by the query generation module 311. Through this, the search module 312 acquires data matching the query generated by the query generation module 311 (information related to the query) as search results. Note that the database 20 need only be constructed to allow searching for data related to the question described above. As the database 20, for example, an internal company database or a paper database can be utilized.

The consistency determination module 313 determines presence or absence of consistency between the question specified by the user and the search results (data acquired as search results by the search module 312).

The prompt generation module 314 generates a prompt by integrating the question and the search results determined by the consistency determination module 313 to be consistent with the question.

The answer generation module 315 generates an answer to the question described above based on the prompt generated by the prompt generation module 314.

Here, the answer generation module 315 in the present embodiment includes the LLM described above.

The LLM is a language model generated by learning a large amount of text data (questions and answers). In a case where a question is input by the learning, it is constructed to generate (output) an answer to the question. That is, in the present embodiment, the answer generation module 315 can generate an answer to the question by inputting the prompt (i.e., the query generated from the question and search results) generated by the prompt generation module 314 into the LLM.

As described above, the answer generated by the answer generation module 315 (LLM) is transmitted to the client terminal 10 via the communication device 33. In this case, the client terminal 10 receives the answer transmitted from the information processing apparatus 30 and displays the received answer on the display device possessed by the client terminal 10. Note that the answer is text data corresponding to a response to the query from the user.

Note that, in FIG. 2, all of the modules 311 to 315 are described as being included within a single device (i.e., the information processing apparatus 30). However, each of these modules 311 to 315 may be distributed and implemented across a plurality of devices, or some of these modules 311 to 315 may be implemented on the client terminal 10.

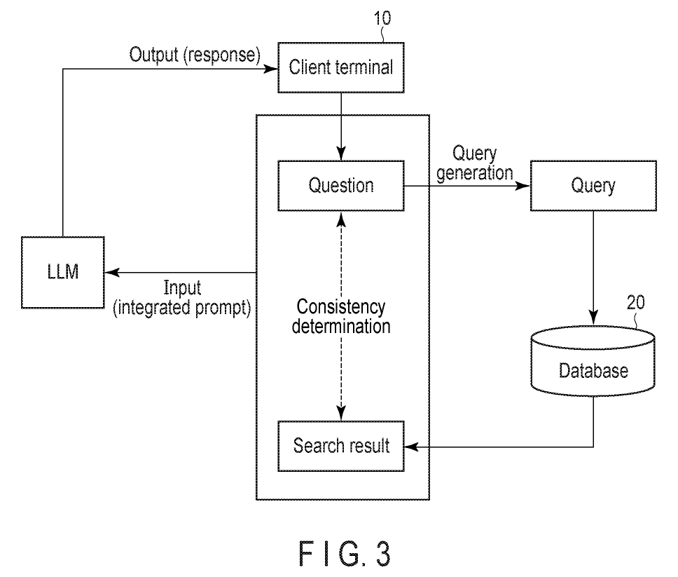

Referring now to FIG. 3, an overview of the operation of the information processing system 1 in the present embodiment will be described.

In the information processing system 1 of the present embodiment, a search is performed on the database 20 using the query generated based on the question specified by the user using the client terminal 10, and the search results are acquired.

Note that, as described above, in a case where the question is text data, the query is, for example, a keyword extracted from the question or an embedded expression of the question (a vector representing the question). In a case where the query is a keyword, text data (document data) including that keyword is acquired as a search result. In a case where the query is an embedded expression, the database 20 stores text data and the embedded expression of the text data in association with each other, and the text data stored in association with the embedded expression similar to the query is acquired as a search result. Note that search processing in the present embodiment may be executed with respect to a plurality of databases 20 or using a plurality of queries (both keywords and embedded expressions).

In the present embodiment, by inputting a prompt (hereinafter referred to as an integrated prompt) that integrates the question and the search results having consistency with that question (data searched from the database 20) to the LLM, an answer to that question output from the LLM is transmitted to the client terminal 10 as a response.

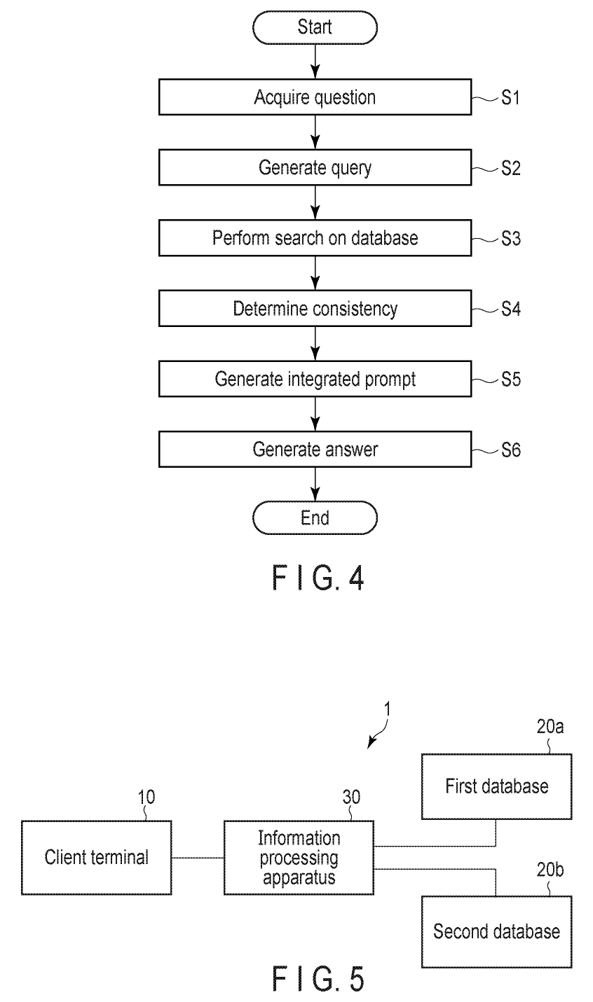

The following describes an example of a processing procedure of the information processing apparatus 30 (processing circuit 31) according to the present embodiment with reference to a flowchart in FIG. 4. Note that the processing shown in FIG. 4 (question-response processing) is executed when a question transmitted from the client terminal 10 is received by the information processing apparatus 30.

First, the query generation module 311 acquires a question received by the information processing apparatus 30 (step S1).

Next, the query generation module 311 generates a query based on the question acquired in step S1 (step S2). Note that, in step S2, a query is generated in a format that allows data related to the question to be searched from the database 20.

The search module 312 performs a search on the database 20 using the query generated in step S2 (step S3).

When the processing of step S3 is executed, the consistency determination module 313 determines presence or absence of consistency (i.e., whether or not the content is consistent) between the question acquired in the aforementioned step S1 and the search result acquired in step S3 (step S4).

The following describes the processing of step S4 (processing determining presence or absence of consistency). In the present embodiment, the processing of step S4 is executed utilizing, for example, the LLM. Specifically, the presence or absence of consistency is determined by inputting, for example, the question, the search result, and the prompt querying presence or absence of consistency into the LLM. Such an LLM utilized for determining presence or absence of consistency may be the LLM included in the aforementioned answer generation module 315 (hereinafter referred to as an answer generation LLM), or may be a different LLM.

Here, the matter of presence or absence of consistency described above is determined based on, for example, a predetermined evaluation criterion. As the predetermined evaluation criterion, for example, similarity, presence or absence of contradictions, or answerability of a question (i.e., whether or not a question can be answered using a search result) can be considered.

In a case where the evaluation criterion is similarity, for example, by inputting a prompt such as “determine whether or not contents of the question and the search result are similar” into the LLM, the presence or absence of consistency between the question and the search result may be determined based on the similarity between the question and the search result output from the LLM. Accordingly, for example, in a case where the degree of similarity between the question and the search result is high (higher or equal to a threshold value), the question and the search result can be determined to have consistency.

In a case where the evaluation criterion is the presence or absence of contradictions, for example, by inputting a prompt such as “check if there are contradictions between the question and the search result” into the LLM, the presence or absence of consistency between the question and the search result may be determined based on the presence or absence of contradictions between the question and the search result output from the LLM. Accordingly, for example, in a case where the contents of the question and the search result do not contradict each other, the question and the search result are determined to have consistency.

In a case where the evaluation criterion is the answerability of the question, for example, by inputting a prompt such as “determine whether or not it is possible to answer the question using the search result” to the LLM, the presence or absence of consistency between the question and the search result may be determined based on the answerability of the question output from the LLM. Accordingly, for example, in a case where a numerical value representing the answerability of the question is high (higher or equal to a threshold value), the question and search result can be determined to have consistency.

Note that the evaluation criterion used to determine the presence or absence of consistency shall be any one of similarity, presence or absence of contradiction, and answerability of the question. However, the presence or absence of consistency may also be determined based on two or more evaluation criteria.

Furthermore, while the processing of step S4 has been described as being executed utilizing the LLM, the processing of step S4 need only be processing that determines whether or not the search result has consistency with the question. For example, it may be executed based on results of morphological analysis performed on the question and the search result. Specifically, the presence or absence of consistency may be determined by using, as an evaluation criterion, the similarity of keywords extracted from the question and the search result by performing morphological analysis, for example. Furthermore, the presence or absence of consistency may be determined by using, as an evaluation criterion, the presence or absence of contradictions between keywords extracted from the question and the search result by performing morphological analysis, for example. Additionally, the presence or absence of consistency may be determined by using, as an evaluation criterion, the answerability of the question based on how frequent the keywords extracted from the question by performing, for example, morphological analysis appear in the search result. Note that the processing of step S4 described above may also be executed using, for example, embedded expressions, etc. generated from the question and the search result.

In a case where it is determined that there is consistency between the question and the search result in step S4 described above, the prompt generation module 314 generates an integrated prompt using the question and the search result (step S5). The integrated prompt is, for example, a prompt describing answering the question using the search result; however, it shall be any prompt reflecting the question and the search result.

Note that, in step S5, the integrated prompt may be generated, for example, by inputting the question and the search result into the LLM. The LLM utilized to generate such an integrated prompt may be the answer generation LLM described above or a different LLM.

When the processing of step S5 is executed, the answer generation module 315 generates an answer to the question using the integrated prompt generated in step S5 and the answer generation LLM (step S6). In this case, the answer generation module 315 acquires the answer output from the answer generation LLM by inputting the integrated prompt into the answer generation LLM.

Although omitted in FIG. 4, the answer generated in step S6 (i.e., the answer to the question specified by the user) is transmitted from the information processing apparatus 30 (processing circuit 31) to the client terminal 10.

Note that, here, although a case in which there is consistency between the question and the search result is described, in a case where there is no consistency between the question and the search result, the processing of steps S5 and S6 is not executed, and the processing shown in FIG. 4 is ended.

Furthermore, the determination result of the presence or absence of consistency described above may be transmitted to the client terminal 10 and notified to the user. In addition, the user may be notified of the determination reason for the presence or absence of consistency along with the determination result of the presence or absence of consistency. Note that, as for the determination reason for the presence or absence of consistency, for example, the degree of similarity of keywords, the keyword serving as the basis for the presence or absence of contradictions, or the numerical value representing the answerability of the question described above may be used.

Incidentally, in the aforementioned step S3, a plurality of data may be searched. In a case where a plurality of data are searched (i.e., in a case where the search result includes a plurality of data), in step S4, presence or absence of consistency between the question and each of the plurality of data is determined. Accordingly, in step S5, for example, an integrated prompt can be generated using only the data that is determined to have consistency with the question among the plurality of data included in the search result. That is, the processing of step 4 can be considered as processing for selecting data that matches the evaluation criterion (i.e., data suitable for generating an answer) from the search result (a plurality of data). Note that, for such data selection, for example, the determination result on the presence or absence of consistency between the plurality of data included in the search result may also be considered. Specifically, for example, in a case where there is no consistency between the plurality of data, the integrated prompt shall not be generated using those plurality of data with no consistency (i.e., only the plurality of data with consistency shall be used).

Note that the processing shown in FIG. 4 above (question-response processing) is one example, and at least part of this processing may be modified. Specifically, at least part of the processing in steps S1 to S6 shown in FIG. 4 may be omitted or replaced with other processing. Furthermore, processing other than steps S1 to S6 shown in FIG. 4 may be added.

As described above, the information processing apparatus 30 according to the present embodiment generates a query for searching data related to a question specified by the user, and acquires a search result (data searched from the database 20) by performing a search on the database 20 prepared in advance (first database) using the generated query. Furthermore, the information processing apparatus 30 according to the present embodiment determines the presence or absence of consistency between the question and the search result, generates an integrated prompt (a prompt integrating the question and the search result) using the question and the search result determined to have consistency with the question, and generates an answer to the question by inputting this generated integrated prompt into the answer generation LLM prepared in advance (first language model).

In the present embodiment, the above configuration enables improvement in the accuracy of the answer to the question specified by the user.

Specifically, for example, in a case where a search result that does not have consistency with the question is obtained, and such a search result is used to query the answer generation LLM for (an answer to) the question, the accuracy (quality) of the answer to the question may decrease due to the influence of the search result that does not have consistency with the question. In contrast, in the present embodiment, since the answer to the question is generated using the search result having consistency with the question, it is possible to suppress the decrease in the accuracy of the answer (i.e., improve the accuracy of the answer).

Note that, in the present embodiment, the presence or absence of consistency is determined based on evaluation criteria such as similarity between the question and search results, the presence or absence of contradictions between the question and search results, or whether or not an answer to the question can be generated using the search results (i.e., answerability of the question). However, the consistency may also be determined by combining a plurality of evaluation criteria or based on other evaluation criteria.

Furthermore, the presence or absence of consistency described above is determined, for example, by inputting the question, the search results, and the prompt querying the presence or absence of consistency into the LLM (a second language model prepared in advance). However, it may also be determined based on the results of morphological analysis with respect to the question and search results (keywords extracted from the text data), etc.

Furthermore, in the present embodiment, the determination result on the presence or absence of consistency may be notified to the user. This allows the user to easily grasp, for example, the search results used to generate the answer to the question (i.e., data determined to have consistency with the question).

Also, in the present embodiment, the question and search results, etc., are described as being mainly text data. However, as long as it is possible to generate an answer to the question utilizing the LLM, for example, the question and search results, etc., may be data in formats other than text data.

### (Second Embodiment)

Next, a second embodiment will be described. In the present embodiment, descriptions of parts identical to those in the aforementioned first embodiment are omitted, and the parts differing from the first embodiment will mainly be described.

FIG. 5 shows an example of a configuration of an information processing system in the present embodiment. Note that, in FIG. 5, the same reference numerals are used for parts identical to those in the aforementioned FIG. 1, and the detailed descriptions thereof are omitted.

As shown in FIG. 5, an information processing system 1 includes a first database 20a and a second database 20b instead of the database 20 shown in FIG. 1.

The first database 20a and the second database 20b correspond to information sources where various data are accumulated, respectively, and are constructed to be accessible from an information processing apparatus 30 connected via a network.

Note that the first database 20a and the second database 20b shall be databases in which at least a portion of the accumulated data is different.

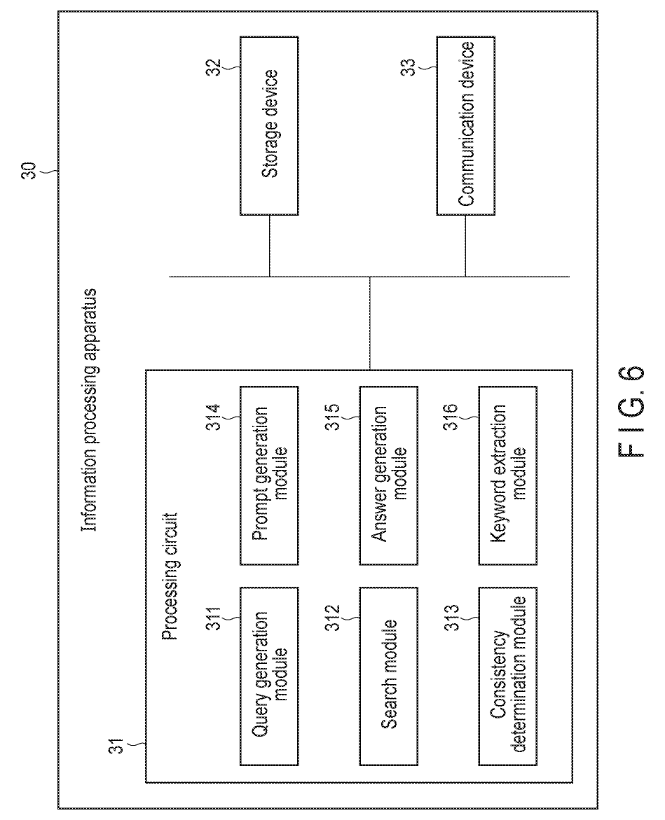

FIG. 6 shows an example of a configuration of the information processing apparatus 30 shown in FIG. 5. Note that, in FIG. 6, the same reference numerals are used for parts identical to those in the aforementioned FIG. 2, and the detailed descriptions thereof are omitted.

As shown in FIG. 6, in the present embodiment, a processing circuit 31 includes a keyword extraction module 316 in addition to the modules 311 to 315 shown in FIG. 2.

In the present embodiment, the keyword extraction module 316 is to be realized by a program stored in a storage device 32 being executed by the processing circuit 31 (processor) (i.e., software). Note that the keyword extraction module 316 may also be realized by, for example, an application-specific integrated circuit.

Here, in the present embodiment, a search module 312 acquires a search result (hereinafter referred to as a first search result) by performing a search, for example, on the first database 20a using a query generated by a query generation module 311.

The keyword extraction module 316 extracts keywords from a question specified by a user and the first search result.

In this case, the search module 312 acquires a search result (hereinafter referred to as a second search result) by performing a search on the second database 20b using the keywords extracted by the keyword extraction module 316.

In the present embodiment, a consistency determination module 313 determines presence or absence of consistency between the question and the first and second search results.

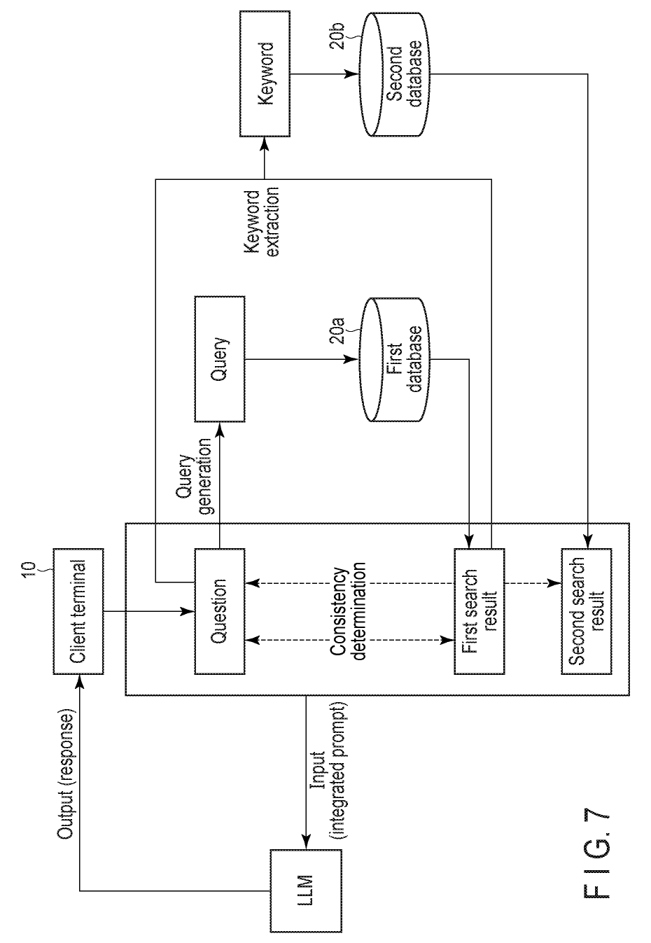

Here, with reference to FIG. 7, an overview of an operation of the information processing system 1 in the present embodiment will be described. Note that, here, parts that are different from the aforementioned FIG. 3 will mainly be described.

The information processing system 1 of the present embodiment differs from the aforementioned first embodiment in that it acquires a first search result from the first database 20a using a query generated based on the question, and acquires a second search result from the second database 20b using keywords extracted from the question and the first search result.

Note that, in the information processing system 1 of the present embodiment, an answer to the question is generated by inputting a prompt (integrated prompt) integrating the question and the first and second search results that are consistent with that question to an LLM.

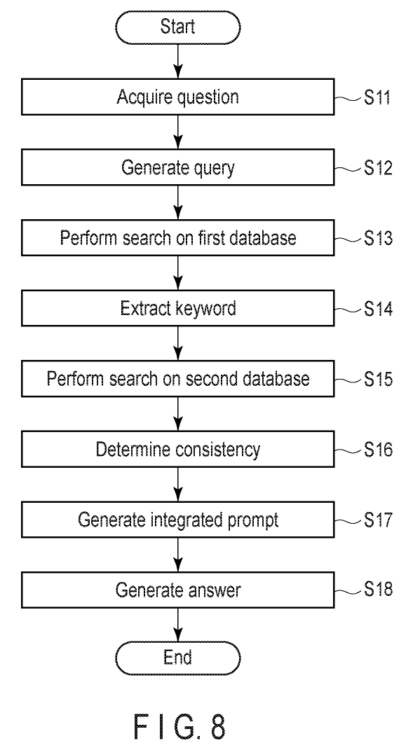

The following describes an example of a processing procedure of the information processing apparatus 30 (processing circuit 31) according to the present embodiment with reference to a flowchart in FIG. 8.

First, processing of steps S11 and S12, similar to the processing of steps S1 and S2 shown in the aforementioned FIG. 4, are executed.

Next, the search module 312 performs a search on the first database 20a using a query generated in step S12 (step S13). The search module 312 acquires the first search result by executing the processing in step S13.

When the processing of step S13 is executed, the keyword extraction module 316 extracts keywords from the question and the first search result (step S14).

Note that the keywords may be extracted, for example, by performing morphological analysis on the question and the first search result, or by inputting the question, the first search result, and a prompt such as “extract keywords important for answering a user's question from the question and the first search result” into the LLM (i.e., querying the LLM for keywords using this prompt). The LLM utilized for such keyword extraction may be an answer generation LLM or a different LLM.

Note that, in step S14, as long as keywords highly relevant to the user's question are extracted, these keywords may be extracted using other methods.

Next, the search module 312 performs a search on the second database 20b using the keywords extracted in step S14 (step S15). The search module 312 acquires the second search result by executing the processing of step S15.

When the processing of step S15 is executed, the consistency determination module 313 determines presence or absence of consistency between the question and the first and second search results (step S16).

Note that, in step S16, for example, the presence or absence of consistency between the question and the first search result is determined, and the presence or absence of consistency between the question and the second search result is also determined. However, since the determination processing for the presence or absence of consistency is as described in the aforementioned first embodiment, detailed descriptions thereof are omitted here.

After the processing of step S16 is executed, processing of steps S17 and S18, corresponding to the processing of steps S5 and S6 shown in the aforementioned FIG. 4, is executed.

Note that, in step S17, for example, a search result determined to have consistency with the question is selected from the first and second search results, and an integrated prompt is generated using the selected search result. When selecting such a search result, for example, the determination result on the presence or absence of consistency in the first and second search results may be considered.

As described above, the information processing apparatus 30 according to the present embodiment extracts keywords from the first search result acquired by performing a search on the question and the first database 20a, and performs a search on the second database 20b using the extracted keywords. The information processing apparatus 30 according to the present embodiment determines the presence or absence of consistency between the question, the first search result, and the second search result acquired by performing a search on the second database 20b, and generates an integrated prompt using the question and the search result determined to have consistency with the question.

In the present embodiment, as described above, since keywords highly relevant to the question extracted from the first search result are used for the search on the second database 20b, it is possible to generate an answer to the question using data with more consistency (i.e., to improve the accuracy of the answer).

Note that, in the present embodiment, keywords can be extracted, for example, by inputting the question, the first search result, and a prompt querying the keywords into the LLM (a third language model prepared in advance). However, they may also be extracted by other methods not utilizing this LLM (e.g., morphological analysis, etc.).

### (Third Embodiment)

Next, a third embodiment will be described. In the present embodiment, descriptions of parts identical to those in the aforementioned second embodiment are omitted, and the parts differing from the second embodiment will mainly be described.

Note that, since a configuration of an information processing system in the present embodiment is the same as that of the aforementioned second embodiment, FIG. 5 will be used as appropriate for explanation.

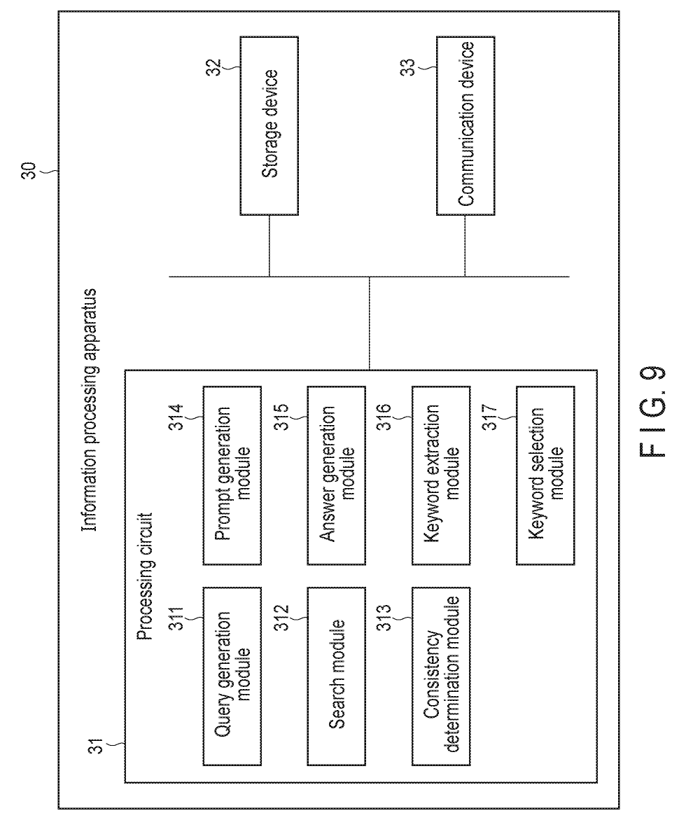

FIG. 9 shows an example of a configuration of an information processing apparatus 30 according to the present embodiment. Note that, in FIG. 9, the same reference numerals are used for parts identical to those in the aforementioned FIG. 6, and the detailed descriptions thereof are omitted.

As shown in FIG. 9, in the present embodiment, a processing circuit 31 includes a keyword selection module 317 in addition to the modules 311 to 316 shown in FIG. 6.

In the present embodiment, the keyword selection module 317 is realized by a program stored in a storage device 32 being executed by the processing circuit 31 (processor) (i.e., software). Note that the keyword selection module 317 may also be realized, for example, by an application-specific integrated circuit.

Here, in the present embodiment, when assuming that a plurality of keywords are extracted by a keyword extraction module 316, the keyword selection module 317 selects a keyword more appropriate for generating an answer from among these plurality of keywords.

In this case, a search module 312 performs a search on a second database 20b using the keyword selected by the keyword selection module 317.

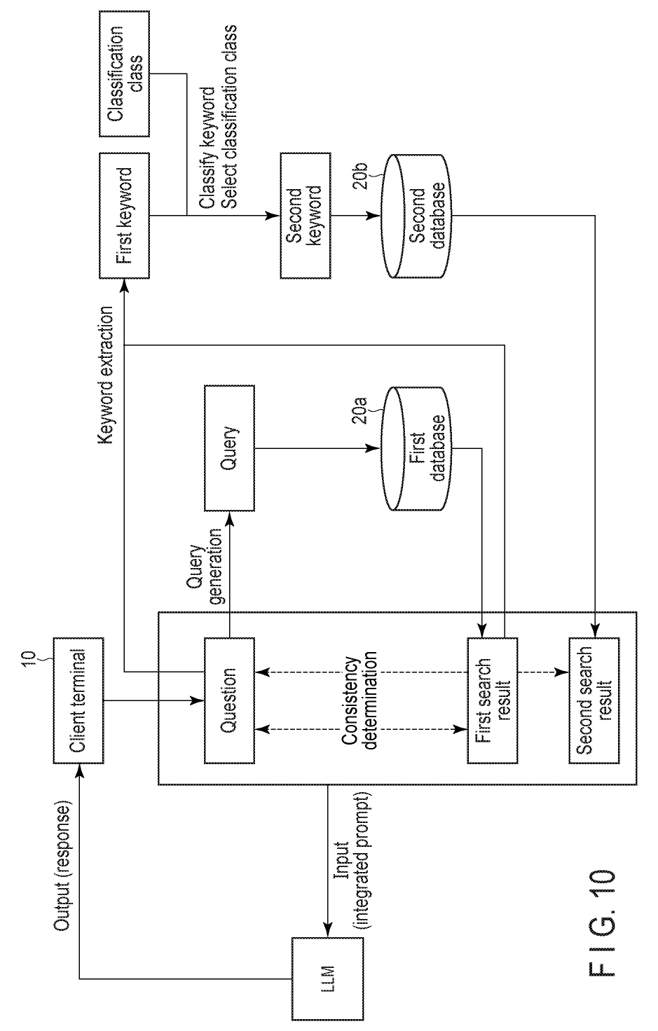

Now, an overview of an operation of the information processing system 1 in the present embodiment will be described with reference to FIG. 10. Note that, here, parts that are different from the aforementioned FIG. 7 will mainly be described.

In the information processing system 1 of the present embodiment, in the same manner as the second embodiment described above, keywords are extracted from a question and a first search result. However, here, a case is assumed in which a plurality of keywords (hereinafter referred to as first keywords) are extracted.

The information processing system 1 of the present embodiment differs from the aforementioned second embodiment in that it classifies the plurality of first keywords into a plurality of classification classes and performs a search on the second database 20b using a second keyword classified into a classification class selected from among the plurality of classification classes. Note that the classification classes correspond, for example, to categories into which predetermined keywords (such as similar keywords) are classified.

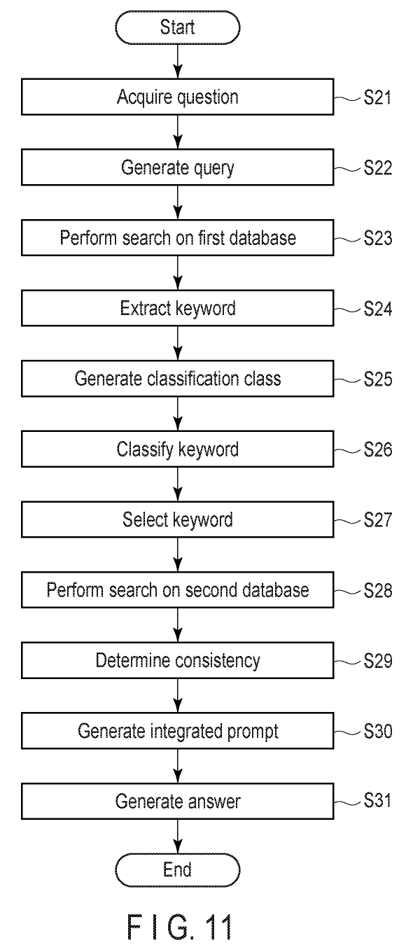

The following describes an example of a processing procedure of the information processing apparatus 30 (processing circuit 31) according to the present embodiment with reference to a flowchart in FIG. 11.

First, processing of steps S21 to S24, corresponding to the processing of S11 to S14 shown in the aforementioned FIG. 8, is executed. Note that, in step S24, it is assumed that a plurality of first keywords are extracted from a question and a first search result.

When the processing of step S24 is executed, the keyword selection module 317 generates a plurality of classification classes for classifying the plurality of first keywords extracted in step S24 (step S25).

In step S5, the classification classes may be generated, for example, based on instructions from a user, etc. who specified the question (i.e., manually), or by inputting a prompt such as “Generate classes for classifying keywords as a preprocessing step for searching data to answer the user's question” into an LLM (i.e., querying the LLM for the classification classes using the prompt). The LLM utilized to generate such classification classes may be an answer generation LLM or a different LLM.

Note that, in step S25, other methods may be employed, such as automatically generating classification classes to which the keywords are classified by utilizing results of morphological analysis with respect to the question (i.e., keywords extracted from the question). Although here the classification classes are described as being generated, the classification classes may also be prepared in advance.

Next, the keyword selection module 317 classifies the plurality of first keywords extracted in step S24 into the plurality of classification classes generated in step S25 (step S26).

In step S26, each of the plurality of first keywords may be classified by inputting, for example, the first keyword, the plurality of classification classes, and a prompt such as “select the classification class to which the first keyword corresponds from among the plurality of classification classes” into the LLM (i.e., querying the LLM for the classification class to which the first keyword is classified using this prompt). The LLM utilized for classifying these first keywords may be the answer generation LLM or a different LLM.

When the processing of step S26 is executed, the keyword selection module 317 selects a second keyword from among the plurality of first keywords based on the classification results of the plurality of first keywords in step S26 (step S27).

In step S27, a second keyword classified into a classification class selected, for example, by inputting the question, the plurality of classification classes, and a prompt such as “select the classification class necessary to answer the user's question from the plurality of classification classes” into the LLM (i.e., querying the LLM for the classification class needed to answer the question using the prompt) is selected. The LLM used for selecting such second keywords may be the answer generation LLM or a different LLM. Note that the selection of classification classes for selecting second keywords may, for example, be based on user instructions.

Next, the search module 312 performs a search on the second database 20b using the second keyword selected in step S27 (step S28).

When the processing of step S28 is executed, processing of steps S29 to S31, corresponding to the processing of steps S16 to S18 shown in the aforementioned FIG. 8, is executed.

As described above, the information processing apparatus 30 according to the present embodiment extracts a plurality of first keywords from the question and the first search result, classifies the extracted plurality of first keywords into a plurality of classification classes, selects a second keyword classified into the selected classification class from the plurality of classification classes, and performs a search on the second database 20b using the selected second keyword.

As described in the aforementioned second embodiment, in a case where keywords are extracted from the question and the first search result, some of the keywords may be unsuitable for searching data to generate an answer to the question. In contrast, in the present embodiment, as described above, the first keywords extracted from the question and the first search result are first classified into classification classes, and the search is then narrowed down to the second keyword classified into the classification class that is presumed to be necessary for the search (i.e., the keyword belonging to that classification class). Therefore, it becomes possible to generate highly accurate answers using data that has even more consistency than in the aforementioned second embodiment.

Note that, in the present embodiment, the classification classes were selected by inputting, for example, the question, the plurality of classification classes, and a prompt querying the classification class necessary to generate an answer to the question into the LLM (a fourth language model prepared in advance). However, the selection of these classification classes may also be realized by other methods not utilizing this LLM. Furthermore, the generation of classification classes and the classification of the first keywords may similarly be performed utilizing the LLM or by other methods.

### Fourth Embodiment

Next, a fourth embodiment will be described. In the present embodiment, descriptions of parts identical to those in the aforementioned second embodiment are omitted, and the parts differing from the second embodiment will mainly be described.

Note that, since configurations of an information processing system and an information processing apparatus in the present embodiment is the same as those of the aforementioned second embodiment, FIG. 5 and FIG. 6 will be used as appropriate for explanation.

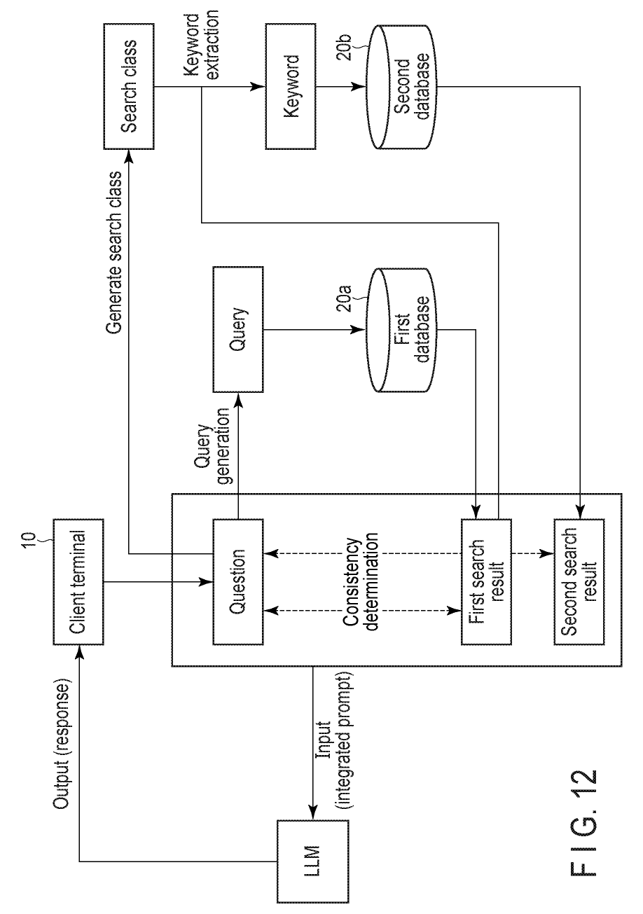

Now, an overview of an operation of an information processing system 1 in the present embodiment will be described with reference to FIG. 12. Note that, here, parts that are different from the aforementioned FIG. 7 will mainly be described.

The information processing system 1 of the present embodiment differs from the aforementioned second embodiment in that it generates a search class corresponding to a keyword for searching data necessary to generate an answer to a question based on that question, and extracts keywords corresponding to that search class from the question and a first search result.

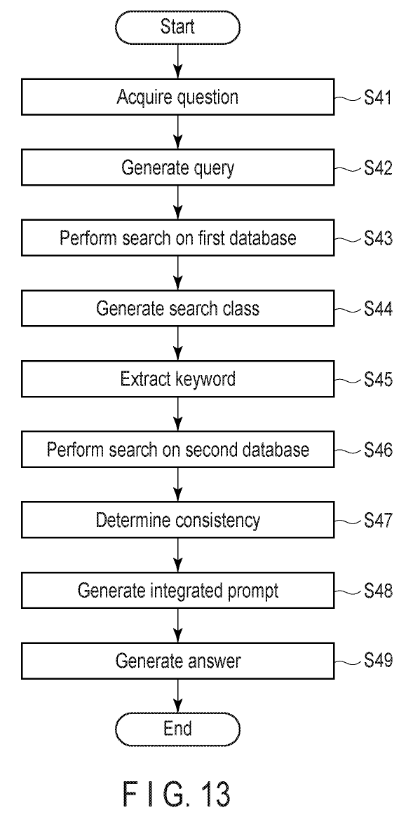

In the following, an example of processing procedures of an information processing apparatus 30 (processing circuit 31) according to the present embodiment will be described with reference to a flowchart in FIG. 13.

First, processing of steps S41 to S43, corresponding to the processing of steps S11 to S13 shown in the aforementioned FIG. 8, is executed.

When the processing of step S43 is executed, a keyword extraction module 316 generates a search class (step S44). Note that the search class may be generated, for example, based on instructions from a user, i.e., specifying a question (i.e., manually), or by inputting a question and a prompt such as “generate a search class necessary to answer the user's question” into an LLM (i.e., querying the LLM for the search class using this prompt). The LLM used to generate such a search class may be an answer generation LLM or a different LLM.

Note that, in step S44, as long as the search class is generated based on, for example, the question, it may be generated using other methods.

Next, the keyword extraction module 316 extracts keywords corresponding to the search class generated in step S44 from the question acquired in step S41 and the first search result acquired by executing the processing of step S43 (step S45). Note that the keywords may also be extracted, for example, by inputting the question, the first search result, and a prompt such as “extract keywords corresponding to the search class from the question and the first search result” into the LLM (i.e., querying the LLM for keywords using this prompt).

When the processing of step S45 is executed, processing of steps S46 to S49, corresponding to the processing of steps S15 to S18 shown in the aforementioned FIG. 8, is executed.

As described above, the information processing apparatus 30 according to the present embodiment extracts keywords corresponding to the search class generated based on a question from the question and the first search result, and performs a search on a second database 20b using the extracted keywords.

As described above, in the second embodiment, the keywords extracted from the question and the first search result may include keywords unsuitable for searching data to generate an answer to the question. However, in the present embodiment, by extracting keywords corresponding to the search class from the question and the first search result and using them for the search, as described above, it becomes possible to generate a highly accurate answer using data with even more consistency than in the aforementioned second embodiment.

Note that, in the present embodiment, the search class was described as being generated by inputting, for example, the question and a prompt querying the search class into the LLM (a fifth language model prepared in advance). However, the generation of the search class may also be realized by other methods not utilizing this LLM. Furthermore, the extraction of keywords corresponding to the search class may be performed utilizing the LLM or by other methods.

According to at least one embodiment described above, an information processing apparatus, an information processing method, and a program capable of improving the accuracy of answers to questions can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor configured to:
generate a query for searching data related to a question specified by a user;
acquire a first search result by performing a search on a first database prepared in advance, using the generated query;
determine presence or absence of consistency between the question and the acquired first search result;
generate a prompt integrating the question and a first search result determined to have consistency with the question; and
generate an answer to the question by inputting the generated prompt into a first language model prepared in advance.

2. The information processing apparatus of claim 1, wherein the processor is configured to determine the presence or absence of consistency based on the similarity between the question and the first search result, presence or absence of contradictions between the question and the first search result, or whether or not it is possible to answer the question using the first search result.

3. The information processing apparatus of claim 1, wherein the processor is configured to determine the presence or absence of consistency by inputting the question, the first search result, and a prompt querying the presence or absence of consistency into a second language model prepared in advance.

4. The information processing apparatus of claim 1, wherein
the question and the first search result include text data, and
the processor is configured to determine the presence or absence of consistency based on keywords extracted from the text data.

5. The information processing apparatus of claim 1, wherein
the question and the first search result include text data,
the processor is configured to:
extract keywords from the text data;
perform a search on a second database different from the first database using the extracted keywords to acquire a second search result;
determine presence or absence of consistency between the question and the acquired first and second search results; and
generate a prompt integrating the question and a search result determined to have consistency with the question.

6. The information processing apparatus of claim 5, wherein the processor is configured to input the question, the first search result, and a prompt querying keywords into a third language model prepared in advance, to extract the keywords.

7. The information processing apparatus of claim 5, wherein
the processor is configured to:
extract a plurality of first keywords from the text data;
classify the extracted plurality of first keywords into a plurality of classification classes and select a second keyword classified into a classification class selected from among the plurality of classification classes; and
perform a search on the second database using the selected second keyword.

8. The information processing apparatus of claim 7, wherein the processor is configured to input the question, the plurality of classification classes, and a prompt querying a classification class necessary to generate an answer to the question into a fourth language model prepared in advance, to select the classification class.

9. The information processing apparatus of claim 5, wherein the is configured to extract a keyword corresponding to a search class based on the question, from the text data.

10. The information processing apparatus of claim 9, wherein the processor is configured to generate the search class by inputting the question and a prompt querying the search class into a fifth language model prepared in advance.

11. The information processing apparatus of claim 1, wherein a determination result of the consistency is notified to the user.

12. An information processing method executed by an information processing apparatus, comprising:
generating a query for searching data related to a question specified by a user;
acquiring a first search result by performing a search on a first database prepared in advance, using the generated query;
determining presence or absence of consistency between the question and the acquired first search result;
generating a prompt integrating the question and a first search result determined to have consistency with the question; and
generating an answer to the question by inputting the generated prompt into a first language model prepared in advance.

13. A non-transitory computer-readable storage medium having stored thereon a program which is executed by a computer, the program comprising instructions capable of causing the computer to execute the function of:
generating a query for searching data related to a question specified by a user;
acquiring a first search result by performing a search on a first database prepared in advance, using the generated query;
determining presence or absence of consistency between the question and the searched first search result;
generating a prompt integrating the question and a first search result determined to have consistency with the question; and
generating an answer to the question by inputting the generated prompt into a first language model prepared in advance.
